(19) United States
(12) Patent Application Publication
(10) Pub. No.: US 2004/0121117 A1
(43) Pub. Date: Jun. 24, 2004

(54) Cushioned carpet for helm of boats

(76) Inventor: John R. Peterson, New Buffalo, MI (US)

Correspondence Address: LITMAN LAW OFFICES, LTD., P.O. BOX 15035 CRYSTAL CITY STATION, ARLINGTON, VA, 22215, US

(21) Appl. No.: 10/325,914

(22) Filed: Dec. 23, 2002

(51) Int. Cl. B32B 3/06

(52) U.S. Cl. 428/99; 428/95

(57) ABSTRACT

A detachable cushioned carpet section for marine use on a boat, in the helm area where a helmsman stands. The carpet section has a pad adhered to its underside to add foot comfort. The carpet section may fit with other removable carpet sections which are removably attached to the boat deck. The carpet sections are typically installed by snapping to the deck and removed by unsnapping for storage when not in use. The helm carpet has a pad which conforms generally to the shape of the carpet section leaving an unpadded border to allow the snap heads mounted along the carpet border to be snapped directly to the studs on the deck surface. The pad is inclined outward at its edges to allow a smooth transition for the supported carpeting from the main portion to the border. The carpet is of the outdoor type to withstand weather effects.

### BACKGROUND OF THE INVENTION

1. Field of the Invention

The present invention relates to boating accessories. More particularly, the present invention relates to a cushioned decking carpet for attachment in the vicinity of the helm for the comfort of a standing helmsman.

2. Description of the Related Art

Many boats provide outdoor type carpeting which is secured to the decking by snaps. The installation of the carpeting is generally done by sections so as to fit irregular surfaces and to ease installation and stowage. Many times the helmsman must stand at the helm for considerable times such as when there is substantial boat traffic, poor visibility, or narrow channels. It would be desirable to provide the helmsman with a carpet section which is cushioned to provide foot comfort when standing. The carpet section could be configured to fit along with other deck carpet sections.

U.S. Pat. No. 4,716,065, issued Dec. 29, 1987, to McLaughlin, describes and underlying pad with a removable carpet fastened to its upper surface.

U.S. Pat. No. 4,824,498, issued Apr. 25, 1989, to Goodwin et al., describes the use of adhesives to bond padding to carpet.

U.S. Pat. No. 5,170,619, issued Dec. 15, 1992, to Reuben, describes a removable floor mat where the lowermost layer is polyurethane foam.

U.S. Pat. No. 5,723,195, issued Mar. 3, 1998, to Paclone describes a carpet and underpad attachment and installation system employing hook and loop material.

U.S. Pat. No. 5,846,461, issued Dec. 8, 1998, to Collins et al., describes a polyurethane foam useful as carpet padding.

None of the above inventions and patents, taken either singularly or in combination, is seen to describe the instant invention as claimed. Thus a cushioned carpet for helm of boats solving the aforementioned problems is desired.

### SUMMARY OF THE INVENTION

The present invention is a detachable cushioned carpet section for marine use on the deck or cockpit sole of a boat, which is intended for placement in the helm area where a helmsman would stand. The carpet section an upper exposed side, an underside, and a perimeter and has foam cushion padding adhered to its underside to add foot comfort when the helmsman stands at the helm for long periods, such as when steering in poor visibility or close quarters. The carpet section may fit with other removable carpet sections which are removably attached to the boat deck. The carpet sections are typically installed by snapping to the deck and removed by unsnapping for storage when not in use. The inventive helm carpet has a central portion and a pad connected by adhesive to the underside of the carpet and conforming generally to the shape of the central portion of the carpet section and leaving an unpadded carpet border portion to allow the snap heads and sockets mounted in and spaced along the carpet border to be snapped directly to the snap studs mounted on the deck surface. The pad is tapered downward and outward along its periphery to allow a smooth transition for the supported carpeting from the central portion to the border. The carpet is of the outdoor type to withstand the effects of water and marine conditions as well as sunlight.

Accordingly, it is a principal object of the invention to provide a detachable padded deck carpet section for use in a marine environment.

It is another object of the invention to provide a padded deck carpet section as above for installation at the helm for comforting the feet of a standing helmsman.

It is a further object of the invention to provide a padded deck carpet section as above having an unpadded border bearing snap sockets for attachment to snap studs attached to the deck.

Still another object of the invention is to provide a padded deck carpet section as above having outdoor type carpeting.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, overhead view of a cushioned carpet for the helm of boats according to the present invention with a carpet corner unsnapped from the boat deck and bent over for illustration purposes.

FIG. 2 is a plan view of the cushioned carpet of FIG. 1.

FIG. 3 is a section view drawn along lines 3-3 of FIG. 2.

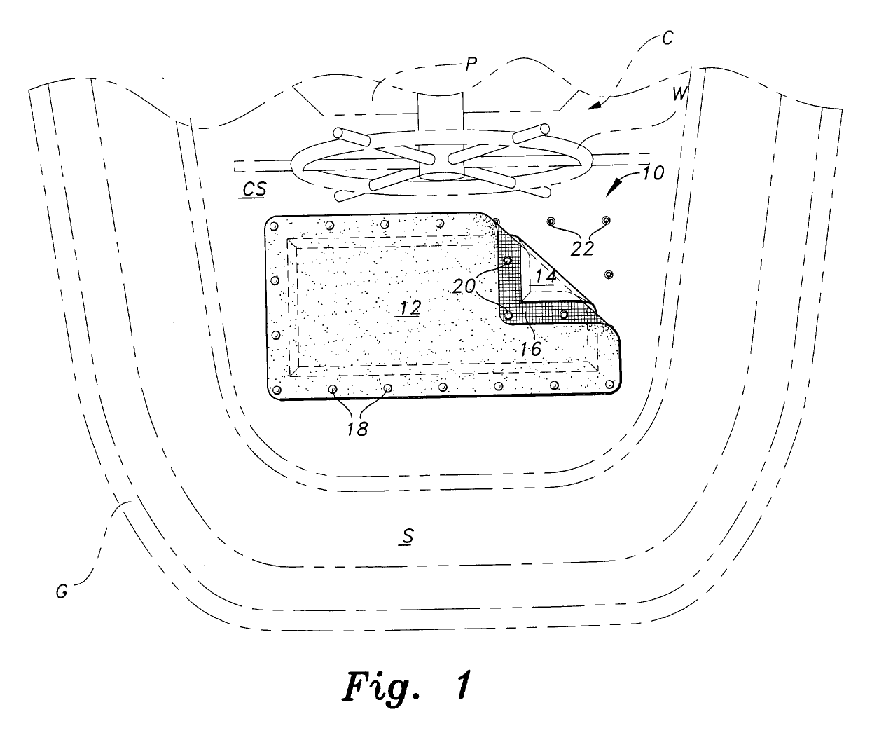

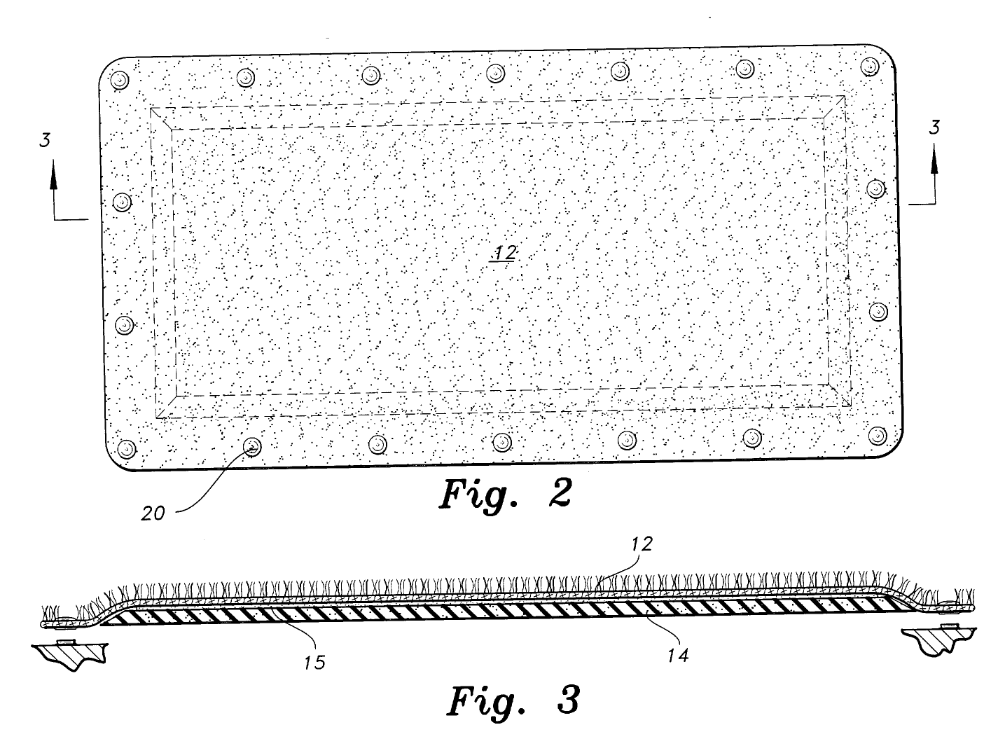

Similar reference characters denote corresponding features consistently throughout the attached drawings.

### DETAILED DESCRIPTION OF THE PREFERRED EMBODIMENT

The present invention is a detachable carpet section for marine use on the deck sole of boat which is intended for placement in the helm area where a helmsman would stand. The carpet section has a pad adhered to its underside to add foot comfort when the helmsman stands at the helm for long periods, such as when steering in poor visibility or close quarters. The carpet section is detachable for storage and is made of outdoor type carpet to withstand water and fading from sunlight.

Referring to the Figures, boat cockpit C includes a deck or cockpit sole CS upon which a pedestal P upon which is mounted the ship's wheel W. A helmsman's seat S is located below the gunnel G. The helmsman sits on seat S or stands while operating the helm wheel W. The helmsman may also operate a throttle, gearshift, and other controls (not shown) typically mounted on the pedestal. The area where the helmsman is located is known as the helm station or helm. The inventive carpet section 10 is removably fastened to the cockpit sole or deck by snaps in the area of the helm between the seat S and the pedestal P such that a standing helmsman may stand on the carpet when operating the helm.

The inventive carpet section 10 is typically rectangular in shape but may be of any desired shape, depending on the particular helm layout. The cushioned carpet section 10 includes outdoor-type carpeting 12 having a foam cushioning pad 14 of a well-known composition attached to its underside by adhesive 15. The pad is centrally located and its periphery and is tapered so as to slope downward and outward when installed on the boat deck, thus smoothing the transition between the padded portion of the carpet section and a surrounding attachment border portion 16. The pad-free attachment border portion 16 surrounds the pad for easy attachment of the carpeting directly to the deck during installation. Although other attachment means or devices may be employed, the use of button-type snaps 20 located in the border and spaced around the carpet section are preferred. Snap sockets 18 are attached to the underside of border 16 and held by caps 17 penetrating through the carpet and flared by an installation tool. Snap studs 22 are permanently attached to the deck or sole such as by adhesive or screws (not shown) and placed to correspond with the snap sockets 18 at the helm location.

During installation, the inventive cushioned carpet section 10 is snapped in place with the padding down by placing the sockets 18 of the snaps 20 over the snap studs 22 and pressing downward until the snaps are secure. The helmsman may then stand on the carpet without fear of its sliding along the cockpit sole or deck. Upon completion of the voyage, the inventive carpet section may be easily unsnapped by pulling upward at the edge of the carpet section, releasing the snaps. The cushioned carpet section 10 may then be stowed in a locker for future use.

The carpeting used in the inventive cushioned carpet section is preferably an outdoor type to withstand a marine environment and may be of any size, shape, and thickness desired. The snaps are preferably made of stainless steel. The thickness of the foam cushioning material is preferably about 3/4 inches. The width of the attachment border is preferably about 1 to 1½ inches with the snaps spaced inward from the outer edge by about 3/8 inches.

It is to be understood that the present invention is not limited to the embodiment described above, but encompasses any and all embodiments within the scope of the following claims.

I claim:

1. A cushioned carpet for the helm of boats comprising:
a section of carpet having an upper side, an underside, and a perimeter;
a cushion padding located on said carpet underside;
means for removably attaching said section of carpet to a boat deck or cockpit sole;
said section of carpet being of such size and shape to cover the deck or sole at the helm station of the boat;
whereby a standing helmsman's feet are cushioned by the cushioned carpet during long periods of standing, such as when operating the boat in poor visibility, weather, or crowded waterways.

2. The carpet of claim 1, wherein said carpet is of the outdoor-type for resistance to water and other marine elements.

3. The carpet of claim 2, said carpet having a central portion surrounded by an attachment border portion, said cushion padding being permanently adhered to and being coextensive with said underside of said carpet central portion.

4. The carpet of claim 3, wherein said cushion padding is foam padding.

5. The carpet of claim 4, said cushion padding is tapered downward and outward around its periphery such that when installed, said carpet central section slopes downwardly to its surrounding said border portion.

6. The carpet of claim 3, wherein said attachment means comprises a plurality of interlocking snaps located within and spaced along said border.

7. The carpet of claim 6, wherein each said snap comprises a socket portion located on the underside of said carpet border portion and a corresponding stud fasted to said deck or cockpit sole, said studs being located so as to maintain said carpet section in the helm position where a helmsman would stand when operating the boat.

8. The carpet of claim 6, wherein said border portion is from about 1 to about 1½ inches in width.

9. The carpet of claim 8, wherein said cushion padding is about 1/2 inches thick.

10. The carpet of claim 9, wherein said carpet section is rectangular in shape.
